(19) United States
(12) Patent Application Publication
(10) Pub. No.: US 2012/0007987 A1
(43) Pub. Date: Jan. 12, 2012

(54) Optical system with automatic switching between operation in daylight and thermovision modes

(75) Inventor: Leonid Gaber, San Leandro, CA (US)

(73) Assignee: American Technologies Network Corporation

(21) Appl. No.: 12/803,728

(22) Filed: Jul. 6, 2010

(51) Int. Cl. H04N 9/68; H04N 5/33

(52) U.S. Cl. 348/164; 348/234; 348/E09.053; 348/E05.09

(57) ABSTRACT

An optical sight system that comprises a combination of a thermal scope with a CCD visual-range attachment connectable to the thermal scope with a quick-release connector. The system is equipped with a device that automatically activates the CCD visual-range attachment when the latter is connected to the thermal scope and with a comparator that compares the video signal of the CCD attachment with the video signal of the thermal scope for sending the brightest video signal to the thermal scope display.

### FIELD OF THE INVENTION

The present invention relates to an optical system that comprises a charge coupled camera (CCD) camera and a thermal scope. More specifically, the invention relates to an optical sight system composed of a thermal scope and a CCD visual-range attachment with automatic switching between the daylight operation mode and the night thermal-vision mode. The optical sight system of the invention is intended for use on a firearm weapon as well as on spotting scopes, binoculars, etc.

### BACKGROUND OF THE INVENTION

Known in the art is a great variety of optical sights, which, according to one variety of classifications, is categorized according to three ranges of operational wavelength: (1) day-vision optical sights; (2) night-vision optical sights; and (3) thermal-vision sights. Daylight optical sights operate in the wavelength range of 400 nm to 700 nm. Night-vision optical sights operate in the wavelength range of near infrared light to 1.7 nm. Thermal-vision sights operate in the middle infrared wavelength range to 13 μm.

Typically, daylight optical sights are used with firearms such as guns or rifles to allow the user to more clearly see a target. Conventional optical sights include a series of lenses that magnify an image and are provided with a reticle that allows the user to align the magnified target relative to the barrel of the firearm. Proper alignment of the optical sight with the barrel of the firearm allows the user to align the barrel of the firearm and, thus, to align the projectile fired therefrom with the target by properly aligning a magnified image of the target with the reticle pattern of the optical sight. A great variety of various modifications exists for day-vision optical sights, such as sights with reticle illumination, red-dot sights, etc.

An example of a conventional day-vision optical sight is disclosed in U.S. Pat. No. 7,411,750 issued on Aug. 12, 2008 to S. Pai. The optical sight includes an outer barrel having opposite ends; ocular and objective lens units mounted respectively to the ends of the outer barrel; a magnification unit disposed tiltably in the outer barrel and extending between the ocular and objective lens units; an adjustment unit mounted on the outer barrel that operates independently and respectively to adjust the position of the magnification unit inside the outer barrel in first and second directions that are perpendicular to each other.

A typical night-vision sight uses an objective lens having a maximized size for maximum light-gathering capability. After passing through the objective lens, light passes through a focusing assembly that is used to vary the distance of light traveling between lenses within the sight by moving either the focal-length adjustment lens, with respect to the objective lens, or a mirror within the night-vision device along the axis that changes the length of the light path. The light is therefore brought into sharp focus on the photosensitive surface of the image intensifier. In a night-vision sight, a photocathode having electrical current flowing therethrough, which forms the photosensitive surface of the image intensifier, converts the optical image into an electronic image that is transmitted through an electron flow. The electrons are accelerated through the image intensifier and remain focused because of the proximity of surfaces within the image-intensifier tube. Acceleration of electrons, combined with a microchannel electron-multiplying plate, results in intensification of the original image. When the electrons reach the screen, the electronic image is converted to an optical image. The final, amplified visible image is displayed to the user or to other optical devices within the night sight.

An example of a night-vision sight is disclosed in U.S. Pat. No. 6,456,497 issued on Sep. 24, 2002 to G. Palmer. This patent describes a night-vision binocular assembly that includes at least one objective lens assembly, an image-intensifier tube, a collimator lens assembly, and a diopter cell assembly encased in easy-to-assemble waterproof housing. The objective lens assembly, image-intensifier tube, collimator lens assembly, and diopter cell assembly are supported by a common base structure within the housing. The device is provided with button controls to operate and adjust the night-vision binocular assembly. The button controls are placed on a common circuit board, which is affixed to the interior of the binocular housing.

Known in the art is a night-vision sight, which is installed on the soldier's helmet and which, for convenience of use under combat conditions and for preventing operation of a light source when the sight is not in use, is provided with automatic switching, depending on the position of the sight on the helmet. Such a device is disclosed, e.g., in U.S. Pat. No. 6,087,660 issued on Jul. 11, 2000 to T. Morris, et al. The night-vision device includes a control circuit having an acceleration-responsive switch. When the night-vision device is in the horizontal position, the acceleration-responsive switch enables a circuit that allows the voltage to be applied to an image-intensifier tube of the night-vision device so that night vision is provided. On the other hand, when the device is flipped up to a stowed position on the helmet, which allows the user of the device unobstructed natural vision, the acceleration-responsive switch senses the changed orientation of the gravitational acceleration vector and turns off the image-intensifier tube as well as other light-emitting sources of the night-vision device. The acceleration-responsive switch controls operation of the voltage step-up circuit, which allows the night-vision device to operate with a single one-and-one-half-volt battery cell, and which also ensures when it is turned off that not only is the image-intensifier tube turned off but also that all other possible sources of light emissions from the night-vision device are turned off.

There exist a variety of image-fusion optical sights in which various modes of image reproduction are used in combination simultaneously or alternatively.

For example, U.S. Patent Application Publication 2007/0035824 published Feb. 15, 2007 (inventor: R. Scholtz) discloses a sighted device operable in visible-wavelength or electro-optical/visible-wavelength sighting modes. The device has a sight that includes an objective lens lying on the optical axis of the sight so that an input beam is coincident with the optical axis; an eyepiece lens lying on the optical axis; an imaging detector having a detector output signal; a signal processor that receives the detector output signal from the imaging detector, modifies the detector output signal, and has a processor output signal; and a video display projector that receives the processor output signal and has a video display projector output. An optical beam splitter lies on the optical axis. The beam splitter allows a first split subbeam of the input beam to pass to the eyepiece lens and reflects a second split subbeam of the input beam to the imaging detector. An optical mixer mixes the first split subbeam and the video display projector output before the first split subbeam passes through the eyepiece lens. According to one aspect of the invention disclosed in U.S. Patent Application Publication 2007/0035824, the imaging detector of the sight may include a silicon charge-coupled device (CCD), a complementary metal oxide semiconductor (CMOS), an intensifier fiber coupled to a CCD, and an InGaAs array. The imaging detector may be located at the objective primary focus.

Another example of a switchable optical sight is a self-contained day/night optical sight disclosed in U.S. Pat. No. 6,608,298 issued on Aug. 19, 2003 to L. Gaber. The device has a sealed sight housing permanently attached to the weapon or to another object and containing an objective lens and an eyepiece lens installed on a common optical path at a distance from each other so that a space is formed between both. The same sealed housing pivotally supports a night-vision unit, such as an image-intensifier tube, which can be turned in the plane that contains the optical axis of the sight between the position offset from the aforementioned common optical axis and the position coincident with the optical axis. Since both night-vision and day-vision optics are located in a sealed housing, the lenses are protected from contamination and fogging. The use of a single optical path makes it possible to reduce the weight of the system. Rotation of the night-vision unit to the working position is interlocked with the day-vision optics so that switching of the sight to night-vision conditions automatically shifts the daytime optics back for the distance required for matching both optics.

A relatively new trend in the field of optical sight is the use of night-vision sights operating on the principle of thermal vision. Such devices are commercially produced, e.g., by Irvine Sensors Corporation (e.g., Miniaturized Low Power Thermal Viewers and Miniature Thermal Imager, Models MTI 3500 320×240 and MTI 6000 640×480).

Another new trend in the field of optical sights is the use of sights with images of targets reproduced by image fusion. In computer vision, multisensor image fusion is defined as the process of combining relevant information from two or more images into a single image. The resulting image is more informative than any of the input images.

An example of a fused thermal and night scope is disclosed in U.S. Pat. No. 7,319,557 issued on Jan. 15, 2008 to A. Tai. The device includes an optical gun sight, a thermal sight, and a beam combiner. The optical sight generates a direct-view image of an aiming point or reticle superimposed on a target scene. The thermal sight generates a monochromic thermal image of the target scene. The combiner is positioned behind the 1× nonmagnified optical sight and the thermal sight and in front of the exit pupil of the thermal sight. The combiner is positioned directly behind the intermediate image plane of the magnified optical sight between the objective lens and the eyepiece. The combiner passes the direct-view image and reflects the thermal image to the exit pupil to fuse the thermal image onto the direct-view image for viewing by the user at the exit pupil as a combined thermal and direct-view optical image of the target scene together with the aiming reticle.

Known devices have various disadvantages. Some of them are large, cumbersome, or cannot be used in a stand-alone state, and therefore they are heavy in weight and unsuitable for use in combat conditions. At the same time, when thermal-vision sights are used in the morning or at dusk, the user must switch or adjust the sight either to night thermovision conditions or to daylight conditions. Alternatively, the user must replace the sight on the weapon in order to reduce total weight of the weapon.

### SUMMARY OF THE INVENTION

An optical sight system is characterized by automatic switching between operation in daylight and thermovision modes. The system consists of a thermal scope and a CCD visual-range attachment with automatic switching between operational modes (i.e., daylight visual mode or night thermal-vision mode). The thermal scope contains its own optical system, a microbolometric array, and a display. Other elements of the system are a disconnectable CCD visual-range attachment, e.g., a part of a CCD visual-range camera attachable to the thermal scope by means of a quick-release connection and operating in conjunction with the display of the thermal scope. The CCD visual-range attachment is also provided with a signal control unit that comprises a microprocessor and a switch connected to the thermal scope.

The thermal scope is provided with an input that is intended for automatic electrical connection with the output of the CCD visual-range attachment when the latter is attached to the thermal scope by the quick-release connection unit. The thermal scope output is permanently connected with the input of the display by a switch and a switch-controlling microprocessor.

The thermal scope operates on the principle of thermal video, detects radiation in the infrared range of the electromagnetic spectrum (7 μm to 13 μm), and produces images of that radiation, referred to as thermograms. Since infrared radiation is emitted by all objects near room temperature, according to the black-body radiation law, thermography makes it possible to see one's environment with or without visible illumination. The amount of radiation emitted by an object increases with temperature; therefore, thermography allows one to see variations in temperature. When viewed through the display of the thermal scope, warm targets are seen brighter than cooler backgrounds. At night time, humans and other warm-blooded animals become easily visible against the environment. As a result, thermography is particularly useful to the military and to security services.

The thermal scope has an uncooled microbolometric array in the form of focal plane array (FPA) sensors located in the thermal image plane. The thermal image is reproduced in the image plane by means of a special germanium-optic lens with high transparency for irradiation in the wavelength range of 7 to 13 μm. The microbolometric array is connected to the microprocessor of the thermal scope for signal collecting, processing, and transmitting to the display. A mid-infrared radiation-receiving element comprises a matrix of microbolometers that provides resolution, e.g., of 320×240 pixels. This resolution is given only as an example.

The CCD visual-range attachment comprises a self-contained unit that can be stored separately from the thermal scope (e.g., in a soldier's pocket, if it is used in connection with a military-sight thermal scope). The attachment has small dimensions and is light in weight (less than 0.5 kg). The attachment contains it own optics of the type used in conventional camcorders with optical characteristics (focal length, field of view, etc.) similar to those of the thermal scope lens but operating in the visible range of wavelengths from UV to near-IR. The aforementioned optics forms an image by means of a CCD array. The CCD visual-range attachment does not have a display and is intended for displaying a daylight image on the display of the thermal scope. The CCD visual-range attachment is provided with its own signal control unit (CCD array electronic support unit) and a comparator that comprises a microprocessor and a switch. When the CCD visual-range attachment is attached to the thermal scope through the quick-release connection unit, it is automatically activated and electrically connected to the thermal scope through the comparator. Furthermore, connection of the CCD visual-range attachment to the thermal scope electrically connects the comparator with the display of the thermal scope.

Thus, when the CCD visual-range attachment is connected and the thermal scope is on, the CCD array electronic support unit sends a daylight visual signal to the comparator which, at the same time, receives a thermal vision signal from the microbolometric array electronic support unit. Under control of the microprocessor, the daylight visual signal of the CCD visual-range attachment is compared with the thermal vision signal of the thermal scope, and under control of the microprocessor the signal with greater brightness is sent through the switch to the display of the thermal scope. Thus, the display reproduces either a daylight visual signal obtained from the CCD visual-range attachment or a night-vision signal from the thermal scope.

More specifically, when illumination of the target is impaired and daylight conditions change to dusk or to night conditions, the switch automatically switches from reproduction of the display image provided by the CCD visual-range attachment to reproduction of the thermogram obtained from the thermal scope, and vice versa. When early-morning poor illumination conditions change to daylight, the switch automatically switches from reproduction of the thermogram provided by the thermal scope to reproduction of the visible image obtained from the CCD attachment. If the thermal scope and CCD attachment are used as an optical military sight, automatic switching of the image on the display is especially important for combat conditions when a soldier may not have time to manually switch devices.

Since the CCD attachment is small and lightweight, it can be disconnected from the thermal scope and stored in a convenient location, e.g., in a pocket. In that case the thermal scope operates in its conventional night-vision mode. When necessary, the CCD attachment can be momentarily attached to the thermal scope through the quick-release connection unit, and the device will operate with automatic switching between daylight visual mode and night thermal-vision mode, depending on the brightness of the visual signal obtained by the comparator.

### BRIEF DESCRIPTION OF THE DRAWINGS

FIG. 1 is a three-dimensional view of the optical sight system that comprises a thermal scope and a CCD visual-range attachment with automatic switching between operation modes. FIG. 2 is a block-diagram of the system of FIG. 1.

### DETAILED DESCRIPTION OF THE INVENTION

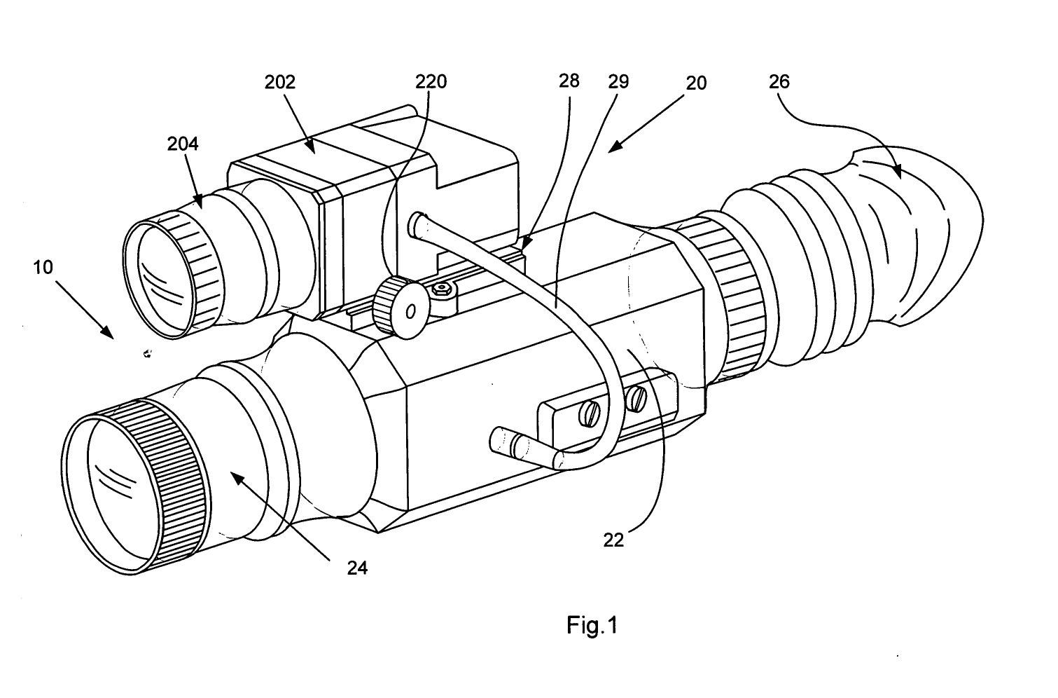

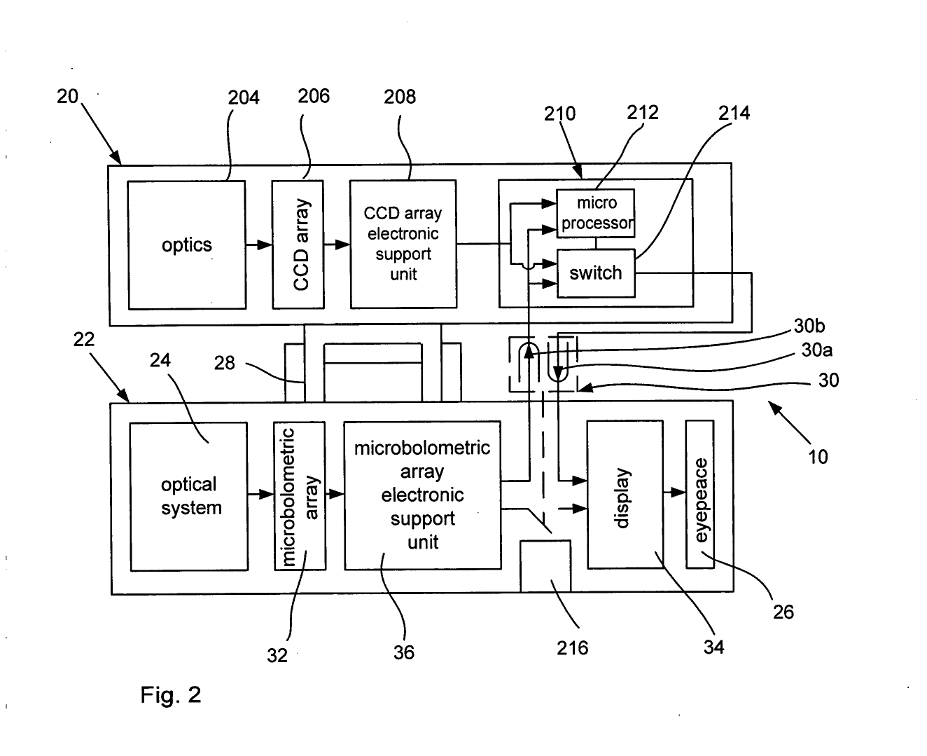

A general three-dimensional view of an optical sight system that comprises a thermal scope and a CCD visual-range attachment is shown in FIG. 1, and a block diagram of the system is shown in FIG. 2. As shown in the drawings, the system, which as a whole is designated by reference numeral 10, comprises a thermal scope 20 and a CCD visual-range attachment 200 with automatic switching between operational modes (i.e., the day-light visual mode or a night-vision thermal-vision mode). Although in the illustrated example the system 10 composed of the thermal scope 20 and a CCD visual-range attachment 200 is shown as an optical sight, other applications such as spotting scopes, binoculars, or the like, are also possible. In other words, the specific example of the optical sight is further described only for illustrative purposes.

The main part of the system 10 is a thermal scope 20, which may comprise a conventional optical-sight type of thermal scope that operates in the wavelength range from 7 to 13.5 μm. In general, thermal scopes of such type can be exemplified by an ATN ThOR 2 device produced by ATN Corp. The ATN ThOR 2 Thermal Optical Riflescope combines the ergonomic features of a handheld device and the convenience of a weapon mounting based on the proven 320×240 microbolometer core. The device is characterized by high-resolution digital thermal imaging. It is compact, lightweight, has a durable housing, can be operational in 3 seconds, and can operate for 6 or more hours with four lithium batteries. The ATN ThOR 2 thermal scope has the following main characteristics: optical system magnification 2× (digital 4×); field of view: 12°×9°; an uncooled microbolometer; spectral response: 7-13 μm; thermal sensitivity: 50 mK; range to detect a live object: 900 m; dimensions (without bracket): 215×77×83 mm; and weight (with batteries): 0.94 kg.

The thermal scope 20 operates on the principle of thermal video, detects radiation in the infrared range of the electromagnetic spectrum (roughly 7 μm to 13 μm), and produces images of that radiation, called thermograms. Since infrared radiation is emitted by all objects near room temperature, according to the black-body radiation law, thermography makes it possible to see one's environment with or without visible illumination. The amount of radiation emitted by an object increases with temperature; therefore, thermography allows one to see variations in temperature. When viewed through the display of the thermal scope 20, warm targets (not shown) are seen brighter than cooler backgrounds. At night time, humans and other warm-blooded animals become easily visible against the environment. As a result, thermography is particularly useful to the military and to security services. The appearance and operation of the thermal scope 22 is similar to a day/night optical scope. The CCD and CMOS sensors used for visible-light cameras are sensitive only to the nonthermal part of the infrared spectrum (NIR). Thermal imaging cameras use specialized focal plane arrays (FPAs) that respond to longer wavelengths (mid- and long-wavelength infrared). The most common types are InSb, InGaAs, HgCdTe, and QWIP FPA. However, sensor arrays of the aforementioned type require special means for cooling.

The optical system 24 may reproduce a thermal image in the image plane by means of special germanium lens optics with high transparency for irradiation in the wavelength range of 7 to 13 μm.

As can be seen in FIG. 1, which shows the external parts of the thermal scope 20, the latter contains a housing 22 that incorporates internal parts, which are shown in FIG. 2 and are described below, a thermal scope optical system 24 supported by the front end of the housing 22, and an eyepiece 26 supported by the rear end of the housing 22. The upper side of the housing 22 is provided with a quick-release connection unit 28. This unit may be of any type known in the art for connection of various attachments, e.g., one used on conventional day- or night-vision optical sights. An example of a quick-release connection unit is an ATN Quick Release Mount produced by ATN Corp. The device has dual locking levers and a weaver mounting system.

The only difference between the thermal scope 20 and a conventional thermal scope is the provision of a video input 30a and a video output 30b (FIG. 2), the purpose of which is explained later in connection with the respective parts of the CCD visual-range attachment 200.

Inside the housing the thermal scope 20 contains a microbolometric array 32 which is connected on one side to the thermal scope optical system 24 and on the other side with a display 34 through a micorobolometric array electronic support unit 36. The thermal scope optical system 24, the microbolometric array 32, and the microbolometric array electronic support unit 36 together form the thermal-vision signal generation unit that generates the aforementioned thermal video signal.

As discussed below in the description of the CCD visual-range attachment 200, connection of the micorobolometric array electronic support unit 36 with the display 34 of the thermal scope 20 can be switched between a position in which the display receives a video signal from the thermal scope 20 or a video signal from the CCD visual-range attachment 200 by the aforementioned video input 30a of the thermal scope 20.

As mentioned above and shown in the illustrated embodiment, the microbolometric array 22b can be of an uncooled type and is made in the form of FPA (matrix) sensors located in the thermal-image plane. The display 34 may comprise a conventional camcorder type of display for observation of the field of view with the eyepiece 26.

The CCD visual-range attachment 200 comprises a self-contained unit that can be stored separately from the thermal scope 20 (e.g., in a soldier's pocket, if it is used in connection with a military-sight thermal scope). The attachment 200 is small and weighs less than 0.5 kg. As mentioned above, the CCD visual-range attachment 26 does not have a display and is intended for displaying a daylight image on the display 24 of the thermal scope 22.

The CCD visual-range attachment 200 is connected to the thermal scope 20 through the quick-release connection unit 28. The electrical connection is carried out through a cable 29 shown in FIG. 1. For adjusting the position of the optical axis of the CCD visual-range attachment 200, the connection unit may be equipped with a conventional windage and elevation mechanism 220 (FIG. 1) of the type described, e.g., in U.S. Patent Application Publication 2010077646 published in 2010 (inventor L. Gaber, et al).

The CCD visual-range attachment 200 may comprise a part of a small CCD visual-range camera but without a display. The CCD visual-range attachment 200 has a housing 202, the front end of which supports a CCD attachment optical system 204 of the type used in conventional camcoders with optical characteristics (focal length, field of view, etc.) similar to those of the thermal scope optics 24 but operating in the visible range of wavelengths from UV to near-IR. The aforementioned optics forms an image by means of a CCD array 206. The CCD array 206 is connected to a CCD array electronic support unit 208. When the CCD visual-range attachment 200 is attached to the thermal scope 24, the CCD array electronic support unit 208 is electrically connected to the display 34 of the thermal scope 20 through a comparator 210 that is installed in the housing 202 of the CCD visual-range attachment 200 (FIG. 2).

The CCD attachment optical system 204, CCD array 206, and CCD array electronic support unit 208 together form a CCD visible-range signal generation unit that generates a video signal from the CCD visual-range attachment 200.

The comparator comprises a microprocessor 212 and a switch 214, the operation of which is controlled by the microprocessor. When the CCD visual-range attachment is attached to the thermal scope through the quick-release connection unit, it is automatically activated and electrically connected to the thermal scope through the comparator. Furthermore, connection of the CCD visual-range attachment to the thermal scope electrically connects the comparator with the display of the thermal scope. More specifically, in FIG. 2 reference numeral 30 designates an electrical connector between the thermal scope 20 and the CCD visual-range attachment 200. This connector 30 connects the output of the CCD visual-range attachment 200 to the video input 30a of the thermal scope and the video output 30b of the microbolometric array electronic support unit 36 to the input of the microprocessor 212. The visual input 30a of the scope can be connected to the display 34 of the thermal scope through the microprocessor-controlled switch 214. When the CCD visual-range attachment 200 is attached to the thermal scope 20, the output of the microbolometric array electronic support unit 36 of the thermal scope 20 is connected to the display 34 of the thermal scope 20 through the same switch 214 since, in this case, the output of the microbolometric array electronic support unit 36 is connected to the microprocessor-controlled switch 214 of the comparator unit 210. However, when the CCD visual-range attachment 200 is disconnected from the thermal scope 20, the output of the microbolometric array electronic support 36 is connected directly to the display 34.

Reference numeral 216 shows a master switch, which is connected to power supply units (not shown) of the thermal scope 20 and of the CCD visual-range attachments 200. When necessary, e.g., for storage, transportation, or repair, the main switch 214 can deactivate the entire system 10.

The system 10 operates as described below.

When the CCD visual-range attachment 200 is connected to the thermal scope 20 by the quick-release connection unit 28, the electrical connector 30 automatically connects the visual input 30a of the thermal scope 20 to the visual output of the switch 214 and connects the visual input of the switch 214 and the visual output 30b of the microbolometric array electronic support unit 36 to the input of the switch 214.

Thus, when the thermal scope 20 is activated and the CCD visual-range attachment 200 is attached, the comparator 210 receives video signals from both the CCD array electronic support unit 208 of the CCD visual-range attachment 200 and from the microbolometric array electronic support unit 36 of the thermal scope 20. Both video signals are compared in the comparator 210 by means of the microprocessor 212 with regard to brightness, and the microprocessor 214 controls operation of the switch 214 so that only the brightest video signal is sent to the display 34 of the CCD visual-range attachment 200.

Thus, when illumination of the target is impaired and daylight conditions change to dusk or to night conditions, the switch 214 automatically switches from reproduction of the display image provided by the CCD visual-range attachment 200 to reproduction of the thermogram obtained from the thermal scope 20, and vice versa. When early-morning poor illumination conditions change to daylight, the switch 214 automatically switches from reproduction of the thermogram provided by the thermal scope 20 to reproduction of the visible image obtained from the CCD attachment 200. This automatic switching of the image on the display 34 is especially important in combat conditions when a soldier may not have time to manually switch devices.

Since the CCD visual-range attachment 200 has small dimensions and is lightweight, it can be disconnected from the thermal scope 20 and stored in a convenient location, e.g., in a pocket. When necessary, the CCD visual-range attachment 200 can be removed from a pocket or other easy-to-reach place and momentarily attached to the thermal scope 20 through the quick-release connection unit 28.

The position of the visual image on the screen of the display 34 can be adjusted with use of the windage and elevation mechanism 220.

When the CCD visual-range attachment 200 is disconnected, the thermal scope 20 operates only in the thermogram-obtaining mode.

Although the invention is shown and described with reference to a specific embodiment, it is understood that any changes and modifications are possible within the scope of the attached patent claims. For example, the optical system with automatic switching between operation in daylight visual mode and thermovision modes applies not only to military optical sights but to other optical devices such as photographic cameras, medical diagnostic instruments, etc. The system may incorporate thermovisors and CCD camcorders of different models. CCD daylight visual attachments are not necessarily devices without display and may comprise conventional, commercially produced camcorders of small dimensions.

1. An optical system with automatic switching between operation in daylight visual mode and thermovision mode comprising:
a thermal scope that comprises a display, a thermal-vision signal generation unit that generates a thermal video signal and that is connected to the display for reproduction of the thermal video signal; and a
CCD visible-range attachment that comprises a CCD visible-range signal generation unit that generates a visible video signal, and a video signal comparator connectable to the display, the thermal vision signal generation unit and the CCD visible-range signal generation unit being connectable to the display of the thermal scope through the comparator, which compares the visible video signal with the thermal video signal and controls operation of the switch by means of the microprocessor so that the brightest video signal is sent to the display through the switch, whereby the display reproduces either the visible video signal or the thermal video signal.

2. The optical system of claim 1, wherein the thermal-vision signal generation unit that generates the thermal video signal comprises a thermal scope optical system, a microbolometric array, and a microbolometric array electronic support unit, wherein the thermal scope optical system is connected to the microbolometric array electronic support unit through the microboloscopic array, and wherein the microbolometric array electronic support unit is connected to the display for transmitting the thermal vision signal.

3. The optical system of claim 1, wherein the CCD visible-range signal generation unit comprises a CCD attachment optical system, a CCD array, and a CCD array electronic support unit, wherein the CCD attachment optical system is connected to the CCD array electronic support unit through the CCD array, and wherein the CCD array electronic support unit is connected to the microprocessor and to the switch of the comparator.

4. The optical system of claim 2, wherein the CCD visible-range signal generation unit comprises a CCD attachment optical system, a CCD array, and a CCD array electronic support unit, wherein the CCD attachment optical system is connected to the CCD array electronic support unit through the CCD array, and wherein the CCD array electronic support unit is connected to the microprocessor and to the switch of the comparator.

5. The optical sight system of claim 1, wherein the CCD visual-range attachment comprises a CCD visual-range camera without a display.

6. The optical sight system of claim 2, wherein the CCD visual-range attachment comprises a CCD visual-range camera without a display.

7. The optical sight system of claim 3, wherein the CCD visual-range attachment comprises a CCD visual-range camera without a display.

8. The optical sight system of claim 4, wherein the CCD visual-range attachment comprises a CCD visual-range camera without a display.

9. The optical sight of claim 5, wherein the connector unit is a quick-release type of connector unit.

10. The optical sight of claim 6, wherein the connector unit is a quick-release type connector unit.

11. The optical sight of claim 7, wherein the connector unit is a quick-release type connector unit.

12. The optical sight of claim 8, wherein the connector unit is a quick-release type connector unit.

13. The optical sight of claim 1, wherein the CCD attachment optical system has an optical axis, and the quick-release type connector further comprises a windage and elevation adjustment mechanism for adjusting the position of the optical axis of the CCD visual-range attachment.

14. The optical sight of claim 2, wherein the CCD attachment optical system has an optical axis, and the quick-release type connector further comprises a windage and elevation adjustment mechanism for adjusting the position of the optical axis of the CCD visual-range attachment.

15. The optical sight of claim 4, wherein the CCD attachment optical system has an optical axis, and the quick-release type connector further comprises a windage and elevation adjustment mechanism for adjusting the position of the optical axis of the CCD visual-range attachment.

16. An optical system with automatic switching between operation in daylight visual mode and thermovision modes comprising:
a thermal scope comprising a thermal scope optical system, a microbolometric array, a microbolometric array electronic support unit, a display, an eyepiece, a video signal output, a video signal input, and a connection unit, the thermal-scope optic system being connected to the microbolometric array electronic support unit through the microbolometric array, and the microbolometric array being connected to the display through the microbolometric array electronic support unit; and
a CCD visual-range attachment connectable to the thermal scope by means of the connection unit, the CCD visual-range attachment having a CCD attachment optical system, a CCD array, and a CCD array electronic support unit, a comparator that comprises a microprocessor, a switch controlled by the comparator, and a CCD attachment video signal output, the CCD attachment optical system being connected to the CCD electronic support unit by the CCD array, and the CCD array being connected to the comparator by the CCD array support unit; when the CCD visual-range attachment being connected to the thermal scope through the connection unit, the microbolometric array electronic support unit is connected to the comparator and the output of the comparator is connected to the display of the thermal scope; the microprocessor of the comparator comparing the video signals of the thermal scope with video signals of the CCD visual-range attachment and controls operation of the switch so that the brightest video signal is sent to the display.

17. The optical sight of claim 17, wherein a connector unit is a quick-release type of connector unit.

18. The optical sight system of claim 18, wherein the CCD visual-range attachment comprises a CCD visual-range camera without a display.

19. The optical sight of claim 19, wherein the CCD attachment optical system has an optical axis, and the quick-release type connector further comprises a windage and elevation adjustment mechanism for adjusting the position of the optical axis of the CCD visual-range attachment.
